(19) United States
(12) Patent Application Publication
(10) Pub. No.: US 2011/0223856 A1
(43) Pub. Date: Sep. 15, 2011

(54) MOBILE COMMUNICATION APPARATUS AND METHOD FOR THE SAME

(75) Inventors: Kazuyuki Ozaki, Kawasaki (JP); Yuuta Nakaya, Kawasaki (JP)

(73) Assignee: FUJITSU LIMITED, Kawasaki-shi (JP)

(21) Appl. No.: 12/881,416

(22) Filed: Sep. 14, 2010

(30) Foreign Application Priority Data
Sep. 17, 2009 (JP) 2009-215948

(51) Int. Cl. H04B 7/14

(52) U.S. Cl. 455/11.1

(57) ABSTRACT

There is provided a mobile communication apparatus capable of being mounted on a mobile body. The mobile communication apparatus includes a plurality of antennas arranged apart each other by certain distances; and a signal regenerator configured to enhance a signal propagating along at least one of detecting directions by summing products obtained by multiplying individual signals received from respective antennas of the plurality of antennas by respective weighting factors which correspond to the one of detecting directions, each of the detecting directions being defined based on a reference depending on a travelling direction of the mobile body.

### CROSS-REFERENCE TO RELATED APPLICATION

This application is based upon and claims the benefit of priority of the prior Japanese Patent Application No. 2009-215948, filed on Sep. 17, 2009, the entire contents of which are incorporated herein by reference.

### FIELD

The embodiments discussed herein are related to a mobile communication apparatus mounted in a mobile object like a vehicle and a method therefor.

### BACKGROUND

An intelligent transport system (ITS) for improving the safety, efficiency, and comfortability of traffic networks have recently been studied. The ITS enables vehicles or passers-by on roads to share various items of information using, for example, dedicated short-range communications (DSRC). The DSRC allows transmission and reception of information between, for example, communication apparatuses mounted in vehicles and between a vehicle-mounted communication apparatuses and roadside devices disposed in the vicinity of roads.

When transmitting signals, individual vehicle-mounted communication apparatuses check whether other vehicle-mounted communication apparatuses transmit signals by performing carrier sensing. The vehicle-mounted communication apparatuses transmit signals when the other vehicle-mounted communication apparatus transmits no signal. However, if there is a shield, such as a building, between the vehicles or if the distance between the vehicles is longer than a distance that allows carrier sensing, the vehicle-mounted communication apparatuses may not sometimes detect signals transmitted from the other vehicle-mounted communication apparatuses. In such a case, the plurality of vehicle-mounted communication apparatuses may transmit signals at the same time. If the plurality of vehicle-mounted communication apparatuses transmit signals at the same time, the signals may collide at a third vehicle-mounted communication apparatus that receives the signals, which may hinder the third vehicle-mounted communication apparatus from regenerating the received signals.

For example, suppose that three vehicles positioned on a straight line each have a communication apparatus, and the distance between vehicles on both sides is longer than a distance at which the vehicle-mounted communication apparatuses can perform carrier sensing. In this case, a communication apparatus mounted in a vehicle at one end may not detect a signal transmitted from a communication apparatus mounted in a vehicle at the opposite end. Therefore, the communication apparatuses mounted in the vehicles at both ends sometimes transmit signals at the same time. When signals are transmitted at the same time from the communication apparatuses mounted in the vehicles at both ends, the two signals collide at a communication apparatus mounted in a vehicle at the center.

A mobile communication technology that enables communications without influence of a shield has been studied (for example, refer to Japanese Laid-open Patent Publication No. 05-167525).

In an example of such a well-known technology, a vehicle-mounted communication apparatus has a plurality of directional antennas having different directivities. The communication apparatus switches the timing to receive signals via the directional antennas. In this well-known technology, the communication apparatus performs a spread spectrum modulation of a transmission signal using a false signal sequence that differs depending on the traveling direction. Thus, the communication apparatus may specify the traveling direction of a vehicle based on a false signal sequence enabling to decode the signal that is transmitted from the vehicle and received by the communication apparatus.

### SUMMARY

According to an aspect of the invention, a mobile communication apparatus capable of being mounted on a mobile body includes a plurality of antennas arranged apart each other by certain distances; and a signal regenerator configured to enhance a signal propagating along at least one of detecting directions by summing products obtained by multiplying individual signals received from respective antennas of the plurality of antennas by respective weighting factors which correspond to the one of detecting directions, each of the detecting directions being defined based on a reference depending on a travelling direction of the mobile body.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic block diagram of a vehicle-mounted communication apparatus according to an embodiment;

FIG. 2 is a schematic block diagram of an example of a signal regenerator;

FIG. 3 is a diagram illustrating an example of the arrangement of antennas;

FIG. 4 is an operation flowchart of a received-signal regenerating process;

FIG. 5 is a schematic block diagram of another example of the signal regenerator;

FIGS. 6A to 6C are diagrams illustrating the relationship between a road or roads around the vehicle and its detecting directions; and

FIG. 7 is an operation flowchart of a detecting-direction selection process.

### DESCRIPTION OF EMBODIMENTS

However, with the above-described technology, the communication apparatus may receive only one of a plurality of signals transmitted from different directions because one directional antenna is available to receive signals at a time.

Thus, it is desired to provide an apparatus and a method for mobile communication capable of regenerating a signal from a communication apparatus present in a desired direction even if a signal collision occurs.

It will be described with reference to the drawings on a vehicle-mounted communication apparatus which is an example of a mobile communication apparatus according to an embodiment. This vehicle-mounted communication apparatus has a plurality of nondirectional antennas (omnidirectional antennas). The vehicle-mounted communication apparatus multiplies signals received via the individual omnidirectional antennas by corresponding weighting factors and demodulates a signal obtained as the sum of the products. The weighting factors are set so as to increase the gain to a signal received from a specific detecting direction. As a result, the vehicle-mounted communication apparatus regenerates the signal received from the specific detecting direction even if receiving a plurality of signals at the same time.

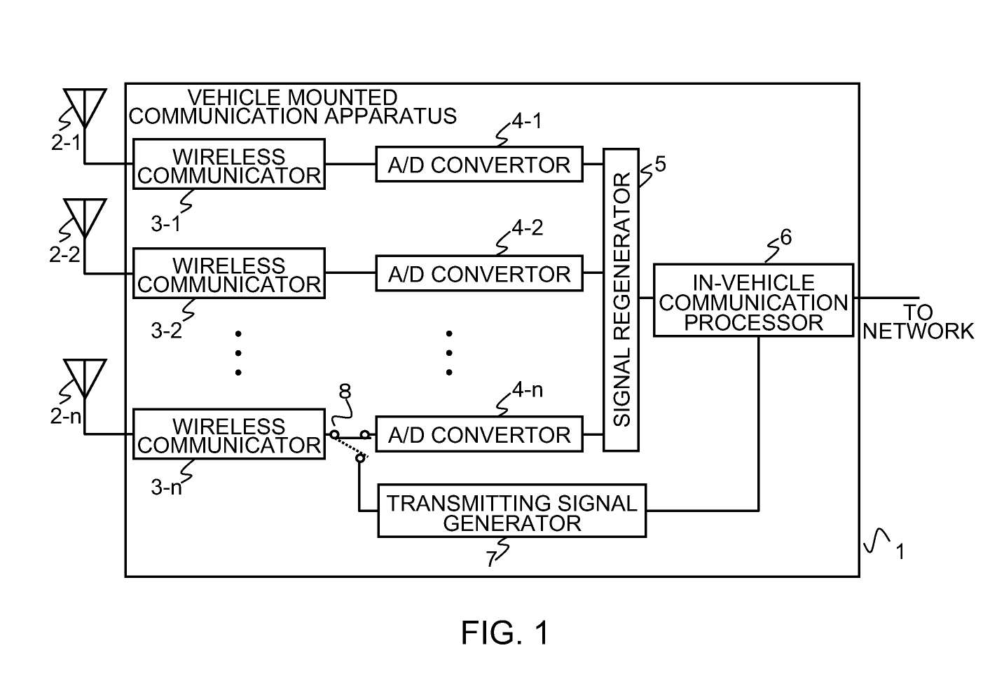

FIG. 1 is a schematic block diagram of a vehicle-mounted communication apparatus 1 according to the first embodiment. The vehicle-mounted communication apparatus 1 includes n (n is an integer greater than or equal to 2) antennas 2-1 to 2-n, n radio communicators 3-1 to 3-n, n analog-to-digital converters 4-1 to 4-n, a signal regenerator 5, an intercommunicator 6, a transmission-signal generator 7, and a switch 8. The antennas 2-1 to 2-n, the radio communicators 3-1 to 3-n, and the analog-to-digital convertors 4-1 to 4-n are representatively referred to as the antennas 2-k or the antenna 2, the radio communicators 3-k or the radio communicator 3, and the analog-to-digital convertors 4-k or the analog-to-digital convertor 4, respectively. The radio communicator 3-k, the analog-to-digital converter 4-k, the signal regenerator 5, the intercommunicator 6, the transmission-signal generator 7, and the switch 8 are configured as separate circuits. Alternatively, those components may be installed, as one integrated circuit in which circuits corresponding to the components are integrated, in the vehicle-mounted communication apparatus 1.

The antennas 2-1 to 2-n are omnidirectional antennas having no directivity. The antennas 2-1 to 2-n are disposed at predetermined intervals so as to be capable of receiving radio signals from directions around the vehicle with the vehicle-mounted communication apparatus 1 or preferably from any direction around the vehicle. Antennas 2-k are connected to corresponding radio communicators 3-k, respectively. The antennas 2-k send radio signals received from other communication apparatuses to the radio communicators 3-k. The antenna 2-n outputs a radio signal received from the transmission-signal generator 7 via the radio communicator 3-n and the switch 8.

The radio communicators 3-1 to 3-n are connected to the antennas 2-1 to 2-n, respectively. The radio communicators 3-1 to 3-(n−1) are connected to the analog-to-digital converters 4-1 to 4-(n−1), respectively. The radio communicator 3-n is connected to one of the analog-to-digital converter 4-n and the transmission-signal generator 7 via the switch 8. The radio communicators 3-k (k=1 to n) each generate an analog baseband signal having a baseband frequency by multiplying a radio signal received via each of the antennas 2-k by a local signal having a local frequency. The radio communicators 3-k output the baseband signals to the analog-to-digital converters 4-k. The radio communicator 3-n generates a radio signal by superimposing a transmission signal received from the transmission-signal generator 7 via the switch 8 onto a carrier wave having a radio frequency and outputs the radio signal to the antenna 2-n.

The analog-to-digital converters 4-1 to 4-n are connected to the radio communicators 3-1 to 3-n, respectively, and to the signal regenerator 5. The analog-to-digital converters 4-k (k=1 to n) convert analog baseband signals received from the radio communicators 3-k to digital baseband signals Bₖ (k=1 to n). The analog-to-digital converters 4-k output the digitized baseband signals Bₖ to the signal regenerator 5.

The intercommunicator 6 has a communication interface circuit for connecting the vehicle-mounted communication apparatuses 1 to an intercommunication network based on a control area network (CAN) or another protocol. The intercommunicator 6 transmits a signal regenerated by the signal regenerator 5 to other devices connected to the intercommunication network. Examples of such devices include a navigation system, an electronic toll collection system (ETC), a driver support system, and an information display device mounted in the vehicle. Upon receiving a signal to be transmitted to another vehicle from another device connected to the intercommunication network, the intercommunicator 6 sends the signal to the transmission-signal generator 7.

For example, the transmission-signal generator 7 modulates a signal received via the intercommunicator 6 in accordance with a predetermined modulation scheme. Using a predetermined multiplexing scheme, the transmission-signal generator 7 may multiplex signals to be transmitted. An example of the modulating/multiplexing scheme is orthogonal frequency division multiplex (OFDM). The transmission-signal generator 7 outputs a transmission signal generated by modulating and/or multiplexing a received signal to the radio communicator 3-n via the switch 8.

The switch 8 switches the connection of the radio communicator 3-n between the analog-to-digital converter 4-n and the transmission-signal generator 7. For this purpose, the switch 8 may be a high-frequency switch, for example.

The signal regenerator 5 is connected to the analog-to-digital converters 4-1 to 4-n and to the intercommunicator 6. The signal regenerator 5 regenerates a signal received from a specific detecting direction on the basis of the baseband signals B₁ to Bₙ digitized by the analog-to-digital converters 4-1 to 4-n. The signal regenerator 5 outputs the regenerated signal to the intercommunicator 6.

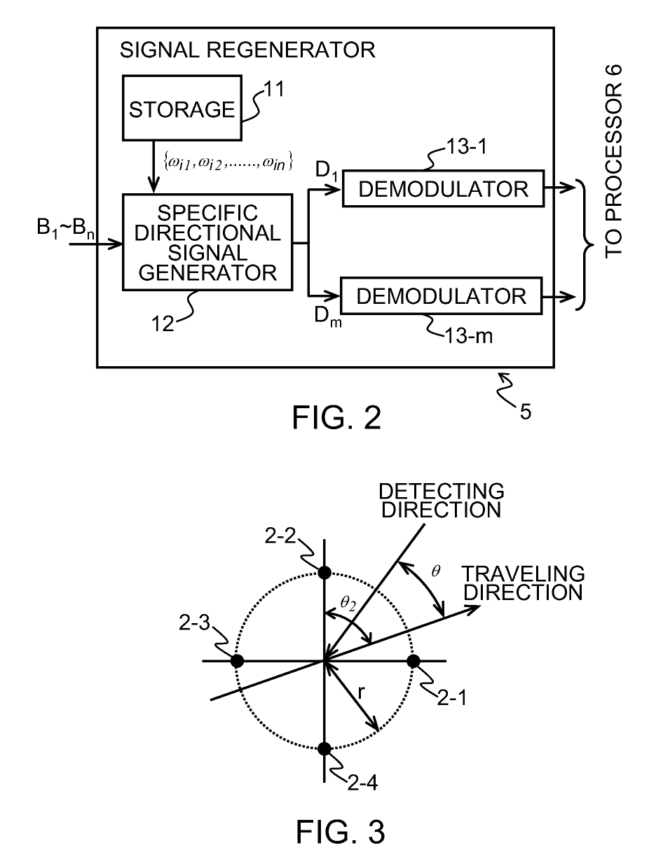

FIG. 2 is a schematic block diagram of the signal regenerator 5. The signal regenerator 5 includes a storage 11, a specific-directional-signal generator 12, and m demodulators 13-1 to 13-m (m is an integer greater than or equal to 1).

The storage 11 has, for example, a nonvolatile rewritable semiconductor memory. The storage 11 stores data of weighting factors ωᵢₖ (k=1 to n) by which the baseband signals B₁ to Bₙ corresponding to radio signals received by the antennas are to be multiplied for m detecting directions i (i=1 to m).

Upon receiving the baseband signals B₁ to Bₙ from the analog-to-digital converters 4-1 to 4-n, the specific-directional-signal generator 12 reads the weighting factors ωᵢₖ from the storage 11. The specific-directional-signal generator 12 generates a specific-directional signal Dᵢ corresponding to a specific detecting direction i (i=1 to m) by summing up values found by multiplying the baseband signals B₁ to Bₙ corresponding to the specific detecting direction i by the weighting factors ωᵢₖ corresponding to the specific detecting direction i as follows:

$${D}_{i} = {\sum }_{k = 1}^{n} {ω}_{ik} {B}_{k} \qquad ( 1 )$$

Upon receiving signals from the specific detecting direction, the weighting factors ωᵢₖ preferably allow individual radio signals received by corresponding antennas 2-k to become in phase. The use of the weighting factors allows the specific-directional-signal generator 12 to intensify radio signals coming from a specific detecting direction via the antennas 2-k, that is, the specific-directional-signal generator 12 enhances a signal or signals propagating along the specific detecting direction. On the other hand, radio signals coming from other directions balance each other. By weighting the baseband signals B₁ to Bₙ using the weighting factor ωᵢₖ determined as described above, the specific-directional-signal generator 12 may therefore increase the gain of a radio signal received from a specific detecting direction. Furthermore, the specific-directional-signal generator 12 may regenerate information included in radio signals received from a plurality of different detecting directions at the same time by generating a specific-directional signal using a weighting factor with which beams are directed to the different detecting directions.

FIG. 3 is a diagram illustrating an example of the arrangement of antennas. In this example, the antennas 2-1 to 2-4 are arranged on the circumference of a circle with a radius of r. The antennas 2-1 to 2-4 are arranged counterclockwise 90° separate from adjacent antennas. The radius r may be, for example, one fourth of the wavelength of a signal transmitted from another vehicle-mounted communication apparatus. In this case, the weighting factors ωₖ (k=1 to 4) for the antennas 2-1 to 2-4 for a signal from a detecting direction that forms an angle θ with the traveling direction of the vehicle having the vehicle-mounted communication apparatus 1 are determined by the following equation:

ωₖ=exp(j(2πr/λ)cos(θₖ−θ)) (2)

where θₖ is an angle that the antenna assembly including the antennas 2-1 to 2-4 form with the traveling direction of the vehicle having the vehicle-mounted communication apparatus 1. The angles θ and θₖ are positive in the counterclockwise direction with respect to the traveling direction of the vehicle. FIG. 3 illustrates an angle θ₂ as an example of θₖ for illustration purpose. Value λ is the wavelength of a reception signal.

The specific-directional-signal generator 12 generates a specific-directional signal corresponding to at least one detecting direction. The detecting direction is determined on the basis of the traveling direction of the vehicle having the vehicle-mounted communication apparatus 1. In this embodiment, examples of the traveling direction include the traveling direction of the vehicle having the vehicle-mounted communication apparatus 1 and a direction opposite to the traveling direction. The specific-directional-signal generator 12 generates, as specific-directional signals, signals corresponding to a signal to be received from the traveling direction of the vehicle and a signal received from the direction opposite to the traveling direction. The use of the specific-directional signals allows the vehicle-mounted communication apparatus 1 to selectively receive a signal transmitted from a vehicle that travels ahead of the vehicle having the vehicle-mounted communication apparatus 1 or a vehicle behind the vehicle.

The specific-directional-signal generator 12 may generate, as specific-directional signals, signals corresponding to a signal from the traveling direction of the vehicle, a signal from the direction opposite to the traveling direction, and a signal from a direction that forms an angle 90° with the traveling direction. Alternatively, the specific-directional-signal generator 12 may generate, as specific-directional signals, signals corresponding to a signal received from the traveling direction of the vehicle and a signal from a direction that forms 45° with the traveling direction. Since the specific-directional-signal generator 12 may generate also individual signals which are received from various different directions from the travelling direction of the vehicle having the vehicle-mounted communication apparatus 1, the vehicle-mounted communication apparatus 1 may receive signals transmitted from the other vehicles around the vehicle having the vehicle-mounted communication apparatus 1. Thus, the vehicle-mounted communication apparatus 1 of the present embodiment may communicate with the other vehicles positioned along a direction of not only 45° or 90° but directions of various degrees from the travelling direction of the vehicle having the vehicle-mounted communication apparatus 1.

The demodulators 13-1 to 13-m are connected to the specific-directional-signal generator 12. The demodulators 13-1 to 13-m each receive one specific-directional signal Dᵢ from the specific-directional-signal generator 12. The demodulators 13-1 to 13-m demodulate the specific-directional signals Dᵢ in accordance with a predetermined modulation scheme. Furthermore, the demodulators 13-1 to 13-m separate the specific-directional signals Dᵢ in accordance with a predetermined multiplexing scheme. The demodulators 13-1 to 13-m regenerate signals transmitted from other communication apparatuses. The modulation/multiplexing scheme used in the modulators 13-1 to 13-m is the same as that the transmission-signal generator 7 uses to modulate and multiplex the transmission signals; for example, OFDM may be used. The demodulators 13-1 to 13-m output the regenerated signals to the intercommunicator 6.

The signal regenerator 5 may have only one demodulator also when generating a plurality of specific-directional signals. In this case, the specific-directional-signal generator 12 temporarily stores the generated specific-directional signals in an internal buffer memory. The specific-directional-signal generator 12 sends the specific-directional signals to the demodulator one by one. The demodulator regenerates the specific-directional signals every reception and outputs the regenerated signals to the intercommunicator 6.

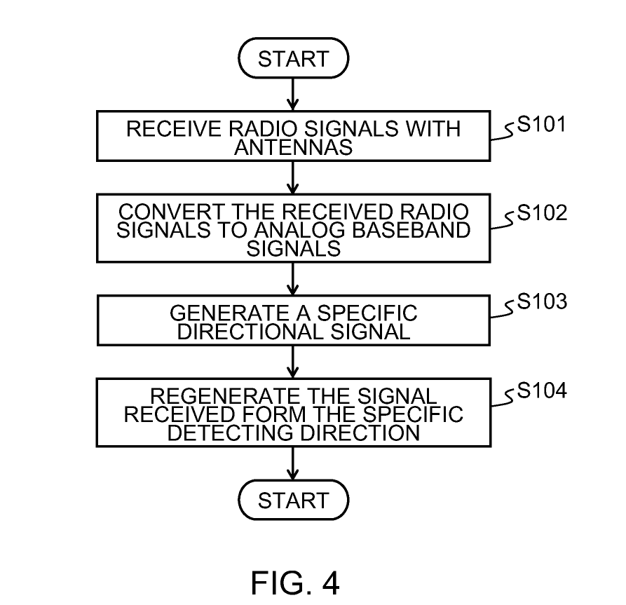

FIG. 4 is an operation flowchart of a received-signal regenerating process of the vehicle-mounted communication apparatus 1. The vehicle-mounted communication apparatus 1 executes the operation below for each frame of the signals.

First, the vehicle-mounted communication apparatus 1 receives radio signals with the plurality of antennas 2-1 to 2-n arranged at predetermined intervals (step S101). The antennas 2-1 to 2-n output the received radio signals to the radio communicators 3-1 to 3-n, respectively.

The radio communicators 3-1 to 3-n convert the received radio signals to analog baseband signals (step S102) to output the analog baseband signals to the analog-to-digital converters 4-1 to 4-n, respectively. The analog-to-digital converters 4-1 to 4-n digitize the analog baseband signals. The digitized baseband signals are input to the signal regenerator 5.

The signal regenerator 5 multiplies the baseband signals corresponding to received signals with the antennas 2-1 to 2-n by weighting factors corresponding to a specific detecting direction and generates the total sum of the products as a specific-directional signal (step S103). If a plurality of detecting directions are set, the signal regenerator 5 generates specific-directional signals corresponding to the individual detecting directions. The signal regenerator 5 demodulates the specific-directional signal to regenerate the signal received from the specific detecting direction (step S104). The signal regenerator 5 outputs the regenerated signal to other devices, such as a navigation system, an ETC, and a driving support system, via the intercommunicator 6.

As described above, this vehicle-mounted communication apparatus regenerates a signal by multiplying radio signals received by omnidirectional antennas by weighting factors that are set to improve the gain of radio signal received from a specific detecting direction and summing up the products. This allows the vehicle-mounted communication apparatus to regenerate a signal received from a specific detecting direction even if receiving a plurality of signals at the same time. Furthermore, the vehicle-mounted communication apparatus may regenerate a plurality of signals received from a plurality of detecting directions at the same time by regenerating the signals using weighting factors corresponding to the plurality of detecting directions. Furthermore, the vehicle-mounted communication apparatus may set its detecting direction depending on the traveling direction. Accordingly, the vehicle-mounted communication apparatus may selectively regenerate a signal from a direction in which another vehicle that transmits a signal to the vehicle-mounted communication apparatus may be present with high possibility. Therefore, the vehicle-mounted communication apparatus may enhance the throughput of communication. Moreover, since the vehicle-mounted communication apparatus may limit the number of detecting directions, the amount of process required for signal regeneration may be reduced.

Modifications of the foregoing embodiment will be described hereinbelow. Another embodiment provides a signal regenerator which determines the detecting direction on the basis of the traveling direction and the present position of a vehicle having the vehicle-mounted communication apparatus and map information on its surroundings.

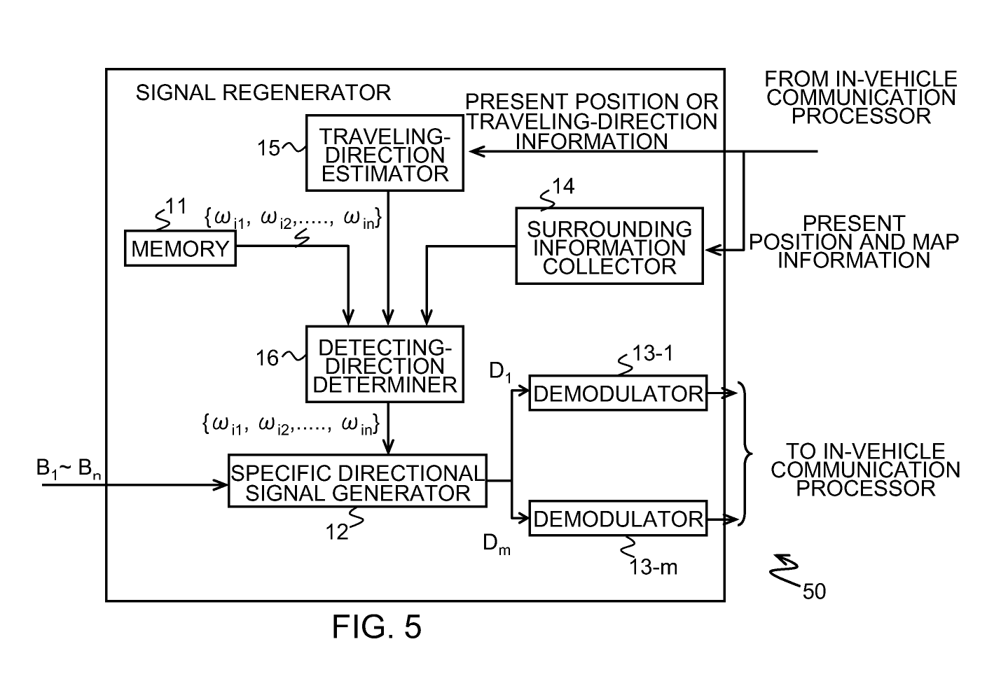

FIG. 5 is a schematic block diagram of an example of the signal regenerator. The signal regenerator 50 illustrated in FIG. 5 includes a storage 11, a specific-directional-signal generator 12, demodulators 13-1 to 13-m, a surrounding-information collector 14, a traveling-direction estimator 15, and a detecting-direction determiner 16. In FIG. 5, of the components of the signal regenerator 50, the same function and configuration as those of the components of the signal regenerator 5 illustrated in FIG. 2 are given the same reference numerals as those of the corresponding components of the signal regenerator 5.

The signal regenerator 50 differs from the signal regenerator 5 only in that it determines the detecting direction on the basis of the present position and the traveling direction of the vehicle having the vehicle-mounted communication apparatus and surrounding map information. The vehicle-mounted communication apparatus according to this embodiment has the same components as those shown in FIG. 1 with the exception of the signal regenerator 50. Thus, determination of a detecting direction and determination of a weighting factor corresponding to the detecting direction will be described hereinbelow.

The storage 11 includes, for example, a nonvolatile rewritable semiconductor memory. The storage 11 stores weighting factors ωᵢₖ (k=1 to n) corresponding to all directions around the vehicle having the vehicle-mounted communication apparatus 1 or a specific direction. In this embodiment, no detecting direction is determined in advance, so that it is preferable that the storage 11 store weighting factors corresponding to all possible detecting directions. For example, the storage 11 stores a plurality of weighting factors for directions in which an angle θ formed with the traveling direction of the vehicle is an integral multiple of 30° or 45°.

The surrounding-information collector 14 regularly acquires present-position information indicating the present position of the vehicle having the vehicle-mounted communication apparatus 1 and map information indicating a map including the present position from a position-information acquisition unit (not shown) via an intercommunication network and an intercommunicator 6. An example of the position-information acquisition unit is a navigation system having a global positioning system (GPS).

The surrounding-information collector 14 extracts possible area information of areas, from the map information, in which a communication apparatus capable of communicating with the vehicle-mounted communication apparatus 1 may be present. For example, the surrounding-information collector 14 extracts road information of roads around the vehicle having the vehicle-mounted communication apparatus 1. The map information generally includes node information of nodes indicating traffic intersections and links indicating roads that connect adjacent traffic intersections. The nodes are associated with, for example, identification information on the nodes, the positions of the nodes, and identification information on links connected to the nodes. The links are associated with, for example, identification information on the links and the positions and lengths of the links.

Thus, the surrounding-information collector 14 sets a search circle with its center at the present position of the vehicle and with a radius of a distance obtained by multiplying the communicable distance of the vehicle-mounted communication apparatus 1 by a predetermined safety factor (for example, 1.1 to 1.5). The surrounding-information collector 14 extracts the link and the node information of the links and the nodes present in the search circle on the basis of the positions of the links and nodes. The surrounding-information collector 14 sets the extracted positions and lengths of the links and the positions of the nodes as surrounding road information.

The surrounding-information collector 14 sends the surrounding road information and the present position information on the vehicle to the detecting-direction determiner 16. If there is a place, such as a parking lot and a gate, where a communication apparatus that transmits a radio signal to the vehicle having the vehicle-mounted communication apparatus 1 may be present around the vehicle, the surrounding-information collector 14 may extract information indicating such a place from the map information. The surrounding-information collector 14 may also send the information indicating such a place to the detecting-direction determiner 16.

The traveling-direction estimator 15 regularly acquires the present position information on the vehicle having the vehicle-mounted communication apparatus 1 from the position-information acquisition unit via the intercommunication network and the intercommunicator 6. The traveling-direction estimator 15 then estimates the traveling direction of the vehicle from the difference between the latest position of the vehicle and the position of the vehicle a certain time before (for example, one or ten seconds before).

Alternatively, the traveling-direction estimator 15 may acquire traveling direction information indicating the traveling direction of the vehicle from the position-information acquisition unit. The traveling-direction estimator 15 notifies the traveling direction of the vehicle to the detecting-direction determiner 16.

In order to point at a possible direction in which a communication apparatus capable of wireless communicating with the vehicle-mounted communication apparatus 1, the detecting-direction determiner 16 determines its detecting direction on the basis of the traveling direction, the present-position information, and the surrounding road information of the vehicle having the vehicle-mounted communication apparatus 1. For example, the detecting-direction determiner 16 determines its detecting directions so that the individual detecting directions agree with corresponding directions along roads around the vehicle. In this case, the detecting-direction determiner 16 may change the number of detecting directions to be set depending on the geometry of the roads around the vehicle.

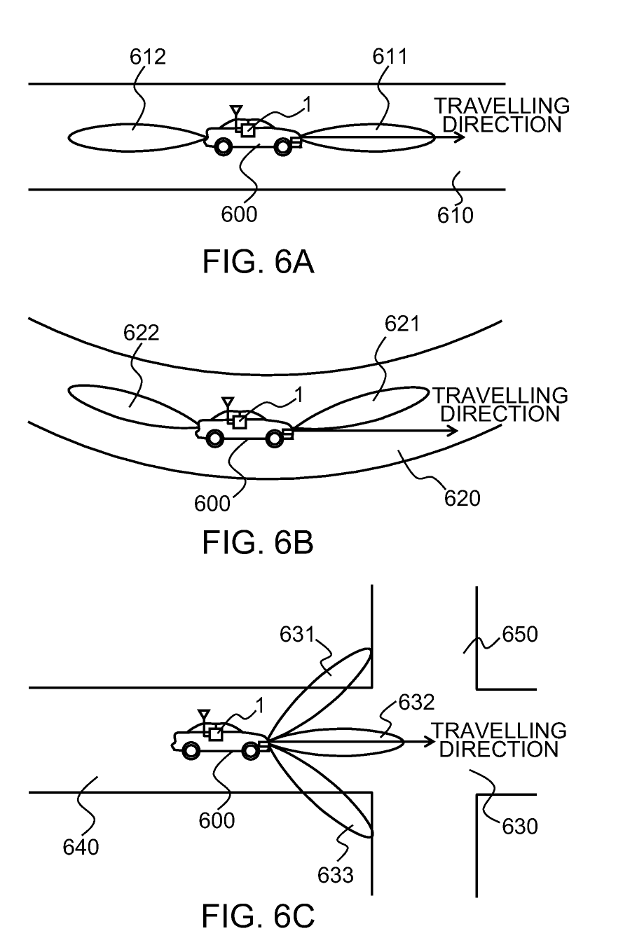

FIGS. 6A to 6C are diagrams illustrating the relationship between a road or roads around the vehicle and its detecting directions. In FIG. 6A, a vehicle 600 having the vehicle-mounted communication apparatus 1 is positioned on a straight road 610 having no intersection. In such a case, another vehicle capable of communicating with the vehicle-mounted communication apparatus 1 may be present only in the traveling direction of the vehicle 600 or in the opposite direction thereto. Thus, the detecting-direction determiner 16 determines the traveling direction 611 of the vehicle 600 and the opposite direction 612 of the traveling direction 611 as its traveling directions.

In FIG. 6B, the vehicle 600 having the vehicle-mounted communication apparatus 1 is positioned on a curved road 620 having no intersection. In such a case, another vehicle capable of communicating with the vehicle-mounted communication apparatus 1 may also be positioned on the curved road 620. Thus, the detecting-direction determiner 16 determines detecting directions 621 and 622 in consideration of, for example, the radius of curvature of the curved road 620 so that a position on the curved road 620 corresponding to the maximum communicable distance of the vehicle-mounted communication apparatus 1 is present on the detecting directions 621 and 622. The detecting-direction determiner 16 may set a plurality of detecting directions that form an acute angle with the traveling direction of the vehicle 600 so that a plurality of positions ahead of the vehicle 600 on the curved road 620 agree with the detecting directions. Likewise, the detecting-direction determiner 16 may set a plurality of detecting directions that form an obtuse angle with the traveling direction of the vehicle 600 so that a plurality of positions behind the vehicle 600 on the curved road 620 agree with the detecting directions.

Furthermore, in FIG. 6C, a road 640 on which the vehicle 600 having the vehicle-mounted communication apparatus 1 travels and a road 650 intersect at an intersection 630 close to the vehicle 600. In such a case, a vehicle capable of communicating with the vehicle-mounted communication apparatus 1 may be positioned on the road 640 or 650. Thus, the detecting-direction determiner 16 sets, for example, the traveling direction of the vehicle 600 and directions that form an acute angle at the right and left with the traveling direction of the vehicle 600 as detecting directions 631 to 633. Accordingly, the vehicle-mounted communication apparatus 1 may detect not only a signal transmitted from a vehicle on the road 640 but also a signal transmitted from a vehicle on the road 650. The detecting-direction determiner 16 may also set the opposite direction of the traveling direction of the vehicle 600 as its detecting direction as in the case of FIG. 6A.

Furthermore, if the intersection 630 is a T-shaped intersection at which the road 640 ends, there is a low possibility that another vehicle is present on the traveling direction of the vehicle 600. Thus, the detecting-direction determiner 16 may set its detecting directions only in directions that form an acute angle at the right and left of the vehicle 600.

The detecting-direction determiner 16 may set a plurality of detecting directions that form an acute angle with the traveling direction of the vehicle 600 so that a plurality of positions on the road 650 agree with the detecting directions. Furthermore, the detecting-direction determiner 16 may set its detecting directions so that angles that the traveling direction of the vehicle 600 forms with the detecting directions increase as the vehicle 600 approaches the intersection 630.

If there is a place, such as a parking lot and a gate, where a communication apparatus capable of wireless communicating with the vehicle having the vehicle-mounted communication apparatus 1 may be present around the vehicle, the detecting-direction determiner 16 may set its detecting direction to such a place.

The detecting-direction determiner 16 reads weighting factors corresponding to the set detecting directions from the storage 11 to output the read weighting factors to the specific-directional-signal generator 12.

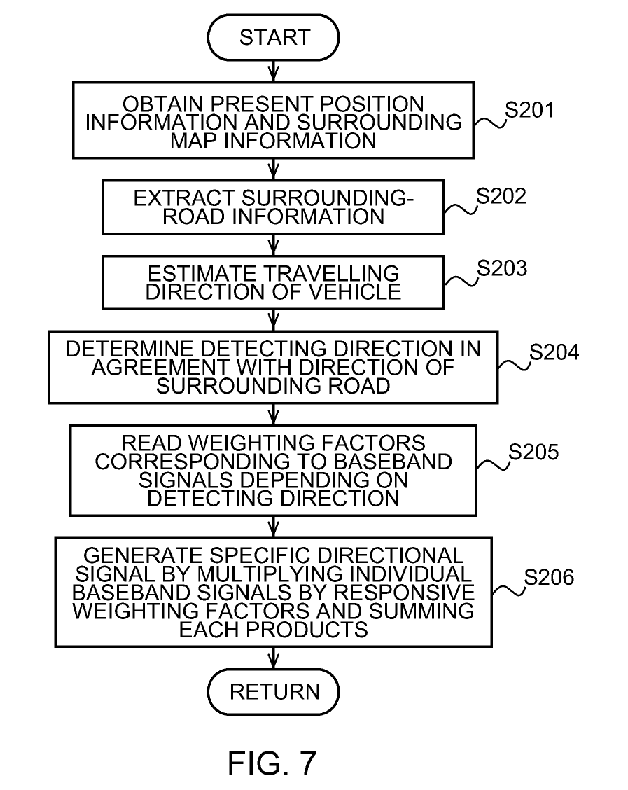

FIG. 7 is an operation flowchart of a detecting-direction selection process. This detecting-direction selection process is executed in step S103 of the flowchart shown in FIG. 4. Alternatively, the operation of steps S201 to S205 in the detecting-direction selection process may be executed in parallel with the operation in steps S101 and S102.

The signal regenerator 50 acquires the present position information of the vehicle having the vehicle-mounted communication apparatus 1 and surrounding map information from the position-information acquisition unit connected via the intercommunication network (step S201). The surrounding-information collector 14 of the signal regenerator 50 extracts road information of roads around the vehicle (step S202). The surrounding-information collector 14 outputs to the detecting-direction determiner 16 the extracted road information indicating the roads and the present position information of the vehicle.

The traveling-direction estimator 15 of the signal regenerator 50 estimates the traveling direction of the vehicle (step S203). The traveling-direction estimator 15 notifies the traveling direction of the vehicle to the detecting-direction determiner 16.

Using the traveling direction information, the present position information, and the surrounding road information associated with the vehicle, the detecting-direction determiner 16 determines a detecting direction so that the detecting direction agree with a direction of a road around the vehicle (step S204).

The detecting-direction determiner 16 reads weighting factors {ωᵢ₁ to ωᵢₙ} corresponding to the determined detecting direction i for the baseband signals B₁ to Bₙ, from the storage 11 (step S205). The detecting-direction determiner 16 sends the read weighting factors {ωᵢ₁ to ωᵢₙ} to the specific-directional-signal generator 12 of the signal regenerator 50.

The specific-directional-signal generator 12 multiplies the individual baseband signals Bₖ by respective weighting factor ωᵢₖ corresponding to the determined detecting direction i and generates the total sum of the products as a specific-directional signal Dᵢ (step S206). If a plurality of detecting directions are set, the specific-directional-signal generator 12 generates specific-directional signals corresponding to the individual detecting directions.

As has been described above, it is provided a detecting direction determined by the vehicle-mounted communication apparatus as a direction in which a vehicle capable of communicating with the vehicle-mounted communication apparatus may be present with high possibility. The determination is performed on the basis of the traveling direction, the present-position information, and the surrounding road information of the vehicle. The vehicle-mounted communication apparatus 1 may therefore enhance the efficiency of receiving a signal transmitted from another vehicle.

According to still another embodiment, the detecting-direction determiner of the signal regenerator may determine its detecting direction on the basis of the relationship between the present position of the vehicle and the roads around the vehicle without using the traveling direction of the vehicle. In this case, whatever direction along the road at the present position the vehicle having the communication apparatus travels, the detecting-direction determiner sets its detecting direction(s) in agreement with surrounding road(s). In this case, the traveling-direction estimator 16 may be omitted from the signal regenerator 50 shown in FIG. 5.

For example, referring again to FIG. 6C, if the vehicle 600 moves to the right, the road 650 comes behind the vehicle. Thus, the detecting-direction determiner sets its detecting directions not only in directions that form an acute angle with the traveling direction of the vehicle 600 but also in directions that form an obtuse angle with the traveling direction of the vehicle 600.

Furthermore, the detecting-direction determiner may calculate a weighting factor corresponding to a determined detecting direction from the positional relationship between the detecting direction and each of the antennas instead of reading from the storage. For example, the detecting-direction determiner may calculate weighting factors for signals detected by the antennas using Eq (2) described above.

The vehicle-mounted communication apparatus may transmit a signal using any of a plurality of communication channels. In this case, when transmitting a signal, the vehicle-mounted communication apparatus detects an unused communication channel by performing carrier sensing for the individual communication channels. The vehicle-mounted communication apparatus transmits a signal using the unused communication channel. In this case, for example, the plurality of communication channels may be time slots set by dividing one frame having a predetermined time length on a time base by time division multiplexing. Alternatively, the communication channels may be any of a plurality of frequency bands divided by frequency division multiplexing. The signal regenerator may determine individual detecting directions for the respective individual communication channels.

The vehicle-mounted communication apparatus may output different transmission signals from the plurality of antennas to enhance communication throughput. In this case, it is preferable that the vehicle-mounted communication apparatus have more antennas than antennas that the other vehicle-mounted communication apparatuses use to transmit signals so as to regenerate signals received from a plurality of the other communication apparatuses at the same time.

The vehicle-mounted communication apparatuses according to the foregoing embodiments may be mobile communication apparatuses mounted in mobile bodies other than vehicles. For example, the mobile communication apparatuses may either be mounted in motorcycles or be carried by pedestrians. The mobile communication apparatuses may receive not only signals transmitted from mobile communication apparatuses mounted in other mobile bodies but also signals transmitted from roadside devices disposed on roads or roadside.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A mobile communication apparatus capable of being mounted on a mobile body comprising:
a plurality of antennas arranged apart each other by certain distances; and
a signal regenerator configured to enhance a signal propagating along at least one of detecting directions by summing products obtained by multiplying individual signals received from respective antennas of the plurality of antennas by respective weighting factors which correspond to the one of detecting directions, each of the detecting directions being defined based on a reference depending on a travelling direction of the mobile body.

2. The mobile communication apparatus according to claim 1, wherein the weighting factors are defined so as to match phases of the individual signals by multiplying the individual signals by the respective weighting factors when the individual signals are received from one of the detecting directions.

3. The mobile communication apparatus according to claim 1, further comprising a detecting direction determiner configured to determine at least one of the detecting directions so that the one of the detecting directions agrees with a direction of a surrounding road associated with the mobile body based on information of the traveling direction, information of a present position of the mobile body, and information of the surrounding road,
wherein the signal regenerator determines weighting factors according to a detecting direction determined by the detecting direction determiner.

4. The mobile communication apparatus according to claim 2, further comprising a detecting direction determiner configured to determine at least one of the detecting directions so that the one of the detecting directions agrees with a direction of a surrounding road associated with the mobile body based on information of the traveling direction, information of a present position of the mobile body, and information of the surrounding road,
wherein the signal regenerator determines weighting factors according to a detecting direction determined by the detecting direction determiner.

5. The mobile communication apparatus according to claim 1, wherein the detecting directions includes the travelling direction of the mobile body and a direction opposite to the travelling direction.

6. The mobile communication apparatus according to claim 2, wherein the detecting directions includes the travelling direction of the mobile body and a direction opposite to the travelling direction.

7. The mobile communication apparatus according to claim 3, wherein the detecting directions includes the travelling direction of the mobile body and a direction opposite to the travelling direction.

8. A method for communication of a mobile transmission apparatus capable of being mounted on a mobile body comprising:
receiving signals with a plurality of antennas arranged apart each other by certain distances; and
enhancing a signal propagating along at least one of detecting directions by summing products obtained by multiplying individual signals received from respective antennas of the plurality of antennas by respective weighting factors which correspond to the one of detecting directions, each of the detecting directions being defined based on a reference depending on a travelling direction of the mobile body.
